(19) United States
(12) Patent Application Publication
(10) Pub. No.: US 2008/0280280 A1
(43) Pub. Date: Nov. 13, 2008

(54) Method of capturing workflow

(75) Inventor: Paul M. Romer, Belmont, CA (US)

Correspondence Address: K&L Gates LLP, STATE STREET FINANCIAL CENTER, One Lincoln Street, BOSTON, MA, 02111-2950, US

(73) Assignee: Aplia, Inc., San Carlos, CA (US)

(21) Appl. No.: 11/803,047

(22) Filed: May 11, 2007

(51) Int. Cl. G09B 5/14

(52) U.S. Cl. 434/356; 434/353

(57) ABSTRACT

The invention relates to methods for capturing, grading, and recording student workflow for both computerized and paper-based input. The workflow is analyzed and graded against a key irrespective of whether the workflow was captured on paper or through the use of computer input. A method of capturing workflow of a solution of a task having an answer by providing a task having a solution to a user or student is provided. The solution is collected and stored to an electronic storage device by extracting the input solution from either a computer interface or a worksheet. The solution is then posted to a user-account.

### FIELD OF INVENTION

The invention relates generally to methods of teaching, more specifically to methods and systems of capturing and recording student workflow.

### BACKGROUND

The utilization of testing and homework in an educational environment is critical to providing an effective education at all levels, perhaps no more so than in elementary or primary education. Often, a teacher possesses minimal resources to effectively create and maintain an environment in which homework and testing best serve the interests of the students. With technological advances in the classroom, computers are becoming a more prevalent tool to aid teachers in the administration of learning exercises, exams, and other projects, both in the classroom and at home.

Traditionally, teachers would assign homework or other projects to students and upon completion would be faced with the daunting task of grading, evaluating, recording and reporting the results of the students' assignments. Manually grading assignments for an entire class of students, sometimes as large as 30 students or more, is a mentally taxing and time consuming effort that limits the time a teacher may have to further enhance the educational experience for his or her students. Time spent grading, recording and reporting may be better spent developing lesson plans, working directly with the students or finding other imaginative ways to enhance and expand the learning environment.

With the advancement of computing technology, teachers have been able to utilize computers and automatic grading and data collection through the use of systems such as those offered by Scantron®, or other data collection and assessment systems. Additionally, many systems and programs exist that allow students to input answers to assignments, exams or other projects directly into a computer terminal. The use of these tools, however, becomes limited when trying to capture and teach the intermediate steps required in many basic problem-solving tasks. The utilization of multiple-choice, computer-readable answer sheets promotes and enables assignments in which only the final answer is relevant. The final answer in many learning environments is less important and instructive than the methods or workflow used by the student in arriving at the final answer.

In certain areas of learning, character-based input is not sufficient to represent the types of output educators would like to test or obtain from students. In certain areas of mathematics, for example, teachers may want to test not only whether students know the numerical answer in an addition problem, but also whether they can construct the appropriate structure and symbolic elements for working through the problem. Traditional computer-readable answer sheets cannot capture the intermediate steps taken to solve a given problem, nor do they enable students to use and manipulate graphical representations in a manner that could assess whether they were using the graphical representations appropriately.

In many circumstances, access to computers in classrooms and homes is limited due to economic, geographic or other constraints. Many households cannot afford a personal computer, and many do not have ready access to one. While some students may have the luxury of having a computer at home on which homework and other learning exercises may be completed, many other students are left at a disadvantage because of the lack of access to such resources. The limited access of some may force a teacher to not utilize such technology at all as it may provide an unfair advantage to those with computer access.

Therefore it would be beneficial to provide a system of teaching, in which a student's workflow is captured, that enables automated grading and reporting irrespective of whether the assignment was completed on a computer or on paper.

### SUMMARY OF THE INVENTION

The invention relates to methods for capturing, grading, and recording student workflow for both computerized and paper-based input. The workflow is analyzed and graded against a key irrespective of whether the workflow was captured on paper or through the use of computer input.

One embodiment of the invention includes a method of capturing workflow of a solution of a task having an answer by providing a task having a solution to a user or student. The solution is collected and stored to an electronic storage device by extracting the input solution from either a computer interface or a worksheet. The solution is then posted to a user-account.

Another embodiment of the invention includes a method of teaching through capturing a workflow of a solution of a task having an answer using either a computer interface or a worksheet. A user is presented with the task and the user selects either the computer interface or the worksheet to complete the task. A submission including a solution is received in which the form of the solution is irrespective of the user's selection of the computer interface or the worksheet. The solution is then posted to a user-specific account located on a server.

Yet another embodiment includes a method of teaching through capturing a workflow process of a student in solving a task having an answer in which the student is presented with the task and the student chooses a computer interface or worksheet for solving the task. The task includes selecting a plurality of discrete elements from a palette for a plurality of solution positions. At least one of the plurality of solution positions includes an indicia of the workflow process used in arriving at the answer. A submission including a solution to the task is received in which the solution includes the location of the plurality of discrete elements in the plurality of solution positions. The solution is irrespective of the student's choice of the computer interface or the worksheet. A student account corresponding to the student is identified and the solution is posted to a server. The server stores the solution in a database entry corresponding to the student account. The solution is compared to a key stored on the server. The key includes the correct locations for the plurality of discrete elements. The comparison is completed irrespective of the student's choice of the computer interface or the worksheet. A composite score is then generated which is based on the correctness of the locations of the plurality of discrete elements in the plurality of solution positions. The composite score is then stored in the database entry corresponding to the student account.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a system diagram of a student workflow capture system in accordance with an embodiment of the present invention;

FIG. 2 is an example of a task presented to a user on a worksheet in accordance with an embodiment of the present invention;

FIG. 3A is an example of a task presented to a user on a computer in accordance with an embodiment of the present invention;

FIG. 3B is an example of a completed task and solution as viewed by the user in accordance with an embodiment of the present invention;

FIG. 4 is a diagram of a solution key and user database structure in accordance with an embodiment of the present invention; and

FIG. 5 is a flow chart of some of the steps of a method of capturing workflow in accordance with an embodiment of the present invention.

### DETAILED DESCRIPTION

The invention will be more completely understood through the following detailed description, which should be read in conjunction with the attached drawings. Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

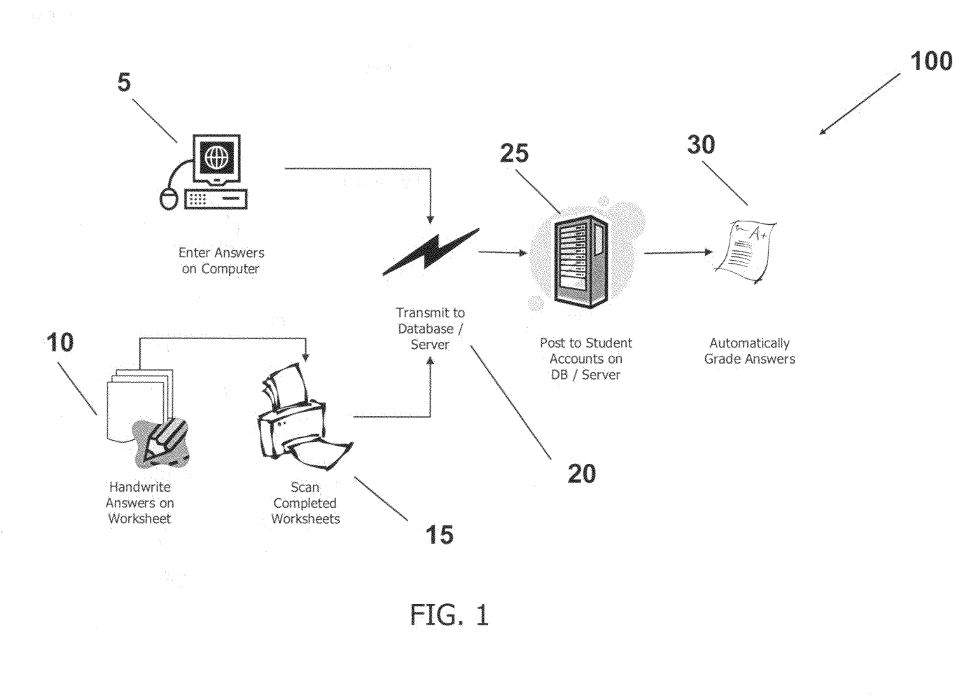

Turning now to FIG. 1, a system diagram 100 of a student workflow capture system in accordance with an embodiment of the invention is shown in which a student is presented with a task, or exercise, such as a homework assignment. A personal computer (“PC”) 5 on a network, or similar electronic input device, may be used to input a solution to the task. The student inputs the answers or completes the task presented and transmits the solution to a database on a server 20. Alternatively, in one embodiment, a student may use a paper worksheet 10 with a task presented thereon. The student may complete the task by writing in the answers on to the worksheet 10. The student then electronically scans 15 the worksheet, during which the solution to the task is extracted from the worksheet. The solution is then transmitted to the database on the server 20. The data collected by the database on the server 20 is irrespective of whether the student completed the task on the PC 5 or on the paper worksheet 10. The database then posts the solution to a user-specific student account 25 on the server 20. The solution is then automatically graded 30 by the server by comparing the uploaded solution from the student to a key stored on the server 20.

In one embodiment, the tasks, or problems, are identically structured regardless of the medium used by the student to capture the solution, or complete the task. A student completing the task on a PC at home has no advantage over a student who opts to complete the same task on a paper worksheet. The solutions may still be electronically analyzed and posted to student accounts automatically, thereby freeing up a teacher's valuable time.

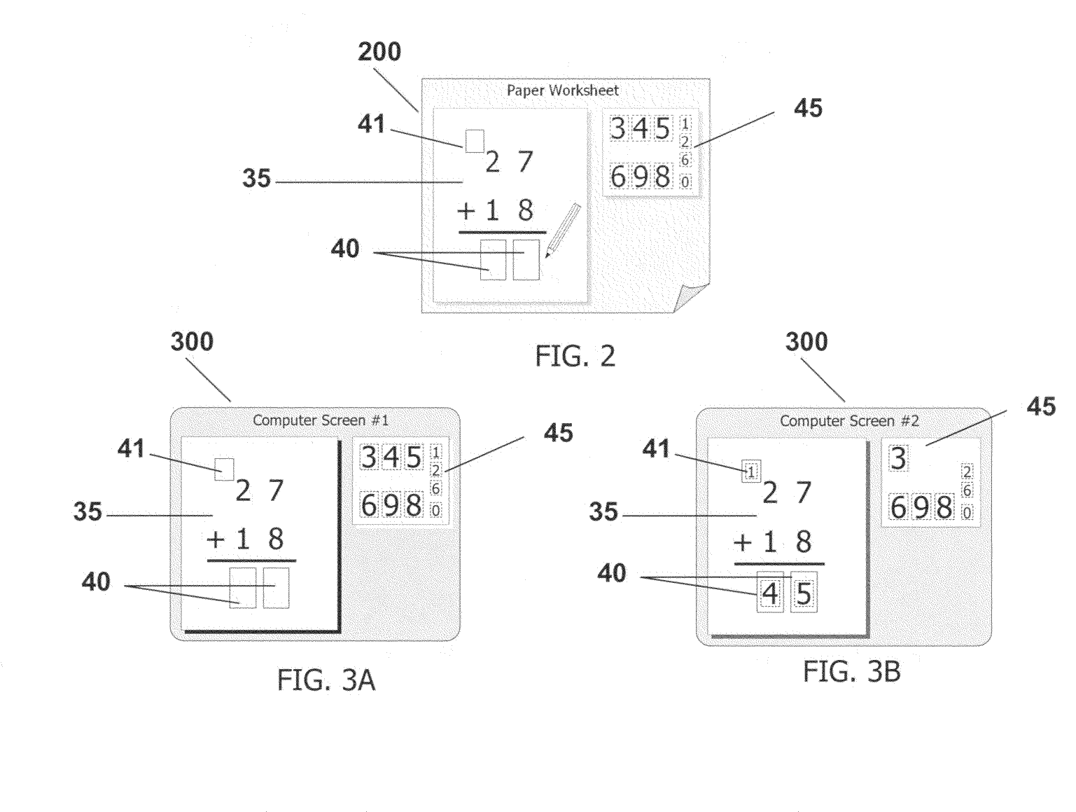

FIG. 2 depicts a sample task, as viewed by a student on a paper worksheet 200 in accordance with an embodiment of the invention. The task includes a problem 35 having a solution made up of discrete answer element locations 40, 41. In the illustrative task of FIG. 2, a mathematics problem is presented. The discrete answer elements 40, 41 indicate to the student what must be completed to correctly solve the task. Not only is the final answer 40 of the illustrative addition problem part of the solution, but the carrying digit 41 is also required. The student is also presented with an answer palette 45 that includes multiple answer elements. The student must select the appropriate elements from the palette 45 and fill in by hand the value of the element in to the answer element 40. The answer element locations and answer elements in the palette, in this embodiment, are delineated by rectangles. To solve the task, the student would select the “1” answer element and record it in the carrying digit 41, the “5” for the answer element location 40 representing the singles digit and the “4” for the answer element location for the tens digit. Once the student has filled in all of the answer element locations with the corresponding answer elements from the palette 45, the solution is complete. The student may then hand-in the worksheet for scanning and the solution may be electronically extracted and transmitted to the server.

Tasks completed on paper worksheets may be scanned via commercially available scanner hardware. The scanner and accompanying software, known in the art, are capable of recognizing marks that identify each problem, for example by problem number, as well as the discrete answer locations 40, 41 in which the student has handwritten his or her answers. The scanner's accuracy in detecting specific input is also improved over standard scanning methods, because the data gathered is limited to demarcated answer locations 40, 41, and the range of possible inputs within these specified boxes is limited to a set of pre-defined answers. The scanner converts these answer elements, i.e., problem numbers and student answers, to a digitally formatted electronic file. The file is then be transmitted over a network to the database on the server.

FIGS. 3A and 3B depict an alternative method of completing a task on a computer screen 300 in accordance with an embodiment of the invention. The student is presented with the task 35 having a number of answer element locations 40, 41 and a palette 45 containing a number of answer elements. Similarly to the worksheet 200 of FIG. 2, the student must solve the task by selecting the appropriate answer elements in the palette 45 for the discrete answer location elements 40, 41 in the task 35. The embodiment also provides a methodology for tracking the workflow of the student by requiring the input of intermediate steps in arriving at the final answer (i.e., selecting the appropriate carrying digit to arrive at the sum). Additionally, the embodiment expands the set of answer inputs beyond the standard keyboard characters to include graphical elements, e.g. mathematical symbols or proofreading marks.

In one embodiment of the invention, a drag-and-drop feature is offered to the student, as depicted by FIG. 3B. The student may click and drag the answer element from the palette across the computer screen 300 using the mouse, or other point-and-click device, and place, or “drop” the answer element in to the corresponding discrete answer location 40, 41. As can be seen in FIG. 3B, the student has solved the illustrative addition problem by placing the “1” element in the carrying digit, the “5” in the ones digit and the “4” in the tens digit. The palette 45 is now missing the answer elements used to solve the task. The drag-and-drop method emulates the similar paper input method of handwriting an answer element into the discrete answer location on the worksheet, as described above.

Once the student has “dropped” answer elements into all the available answer locations, the solution is complete and the student may then submit the solution for posting and grading. Each solution submitted by a student from a PC is electronically transmitted over the network to the database on the server.

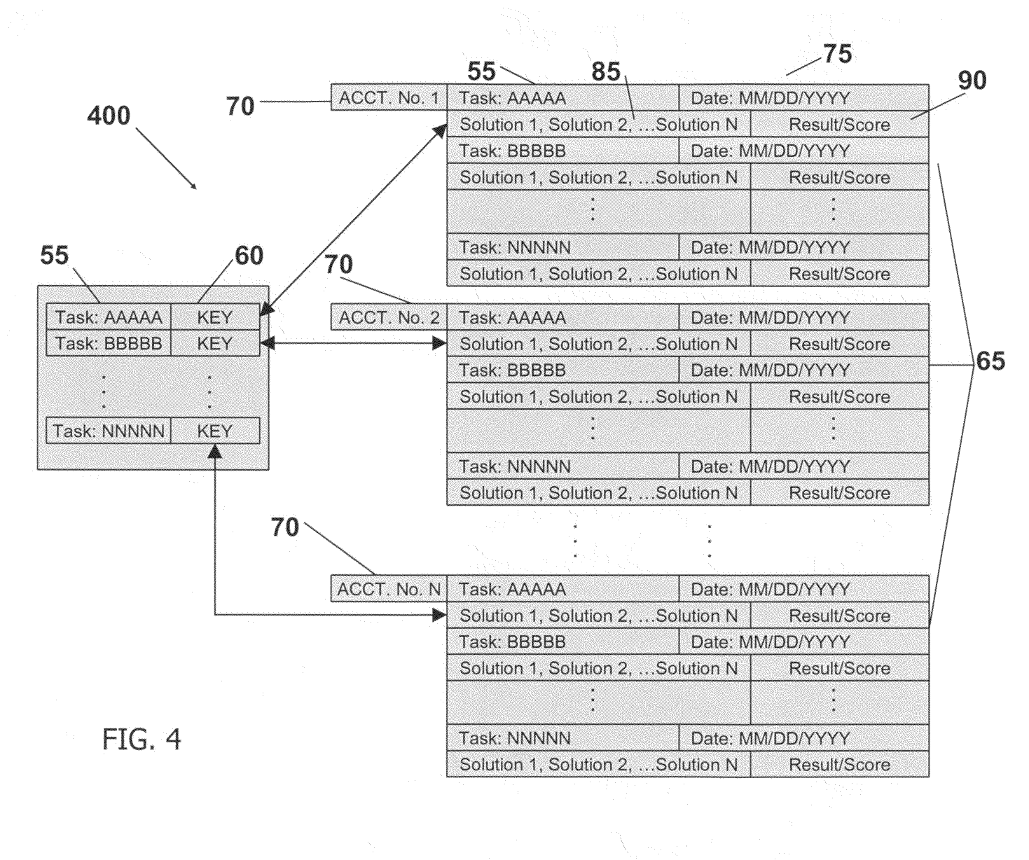

The database on the server, in one embodiment, contains individual student accounts that maintain submitted solutions and other related data. FIG. 4 depicts a data structure 400 of the student accounts 65 and grading key table 50 in accordance with an embodiment of the invention. All submitted answers, regardless of input method, are marked by a student identifier 70, such as an account number or other unique ID, associated with an account. This account 65 comprises a record of the student's cumulative answer solutions 85, organized by problem set 55 and date 75. Each time data is uploaded, the solution submissions 85 are recorded and posted to the appropriate student account. The structure also includes a key table 50, or structure, that maintains the correct solutions 60 for each task organized by task 55, or task identifier.

In the illustrative structure of FIG. 4, the student identifier 70 is an account number. Associated with each account number 70 is a task 55, or task identifier, the solution 85 submitted by the student, the date of the submission 75 and the results or score 90. All submitted solutions are then cross-checked against an answer key 60 corresponding to the task 55 that resides on the database. The problems are automatically scored as correct or incorrect, and a composite score for each student's submission is recorded to her account in the result/score field 90 corresponding to the task 55.

If the student receives an unsatisfactory score or result, he may complete the task again attempting to improve the score. The second submitted solution is concatenated to the first in the solution field 85. A student may repeat the task as many times as required to achieve a satisfactory score. The illustrative method may be used in conjunction with any existing system for tracking student progress over time. The data elements can be exported to each student's file, which would accumulate corrected problem set scores over time. This would serve as a record of student progress, and also enable students, instructors, and other interested parties to focus in on subject matter areas of competence and weakness, both at the individual and class (or other group) level.

Once all student submissions have been graded and recorded, the system can provide feedback to students regarding the correct answers to the problems they completed—all problems, or just the problems they missed or were marked incorrect. This is achieved either by on-screen explanations when PCs are available or on printed explanation sheets in situations which paper-based work is the only option.

Although the embodiments contained herein describe a data structure, including certain fields, to record and maintain student data, one skilled in the art should recognize that any suitable structure and any desired metric may be included without out deviating from the scope of the invention.

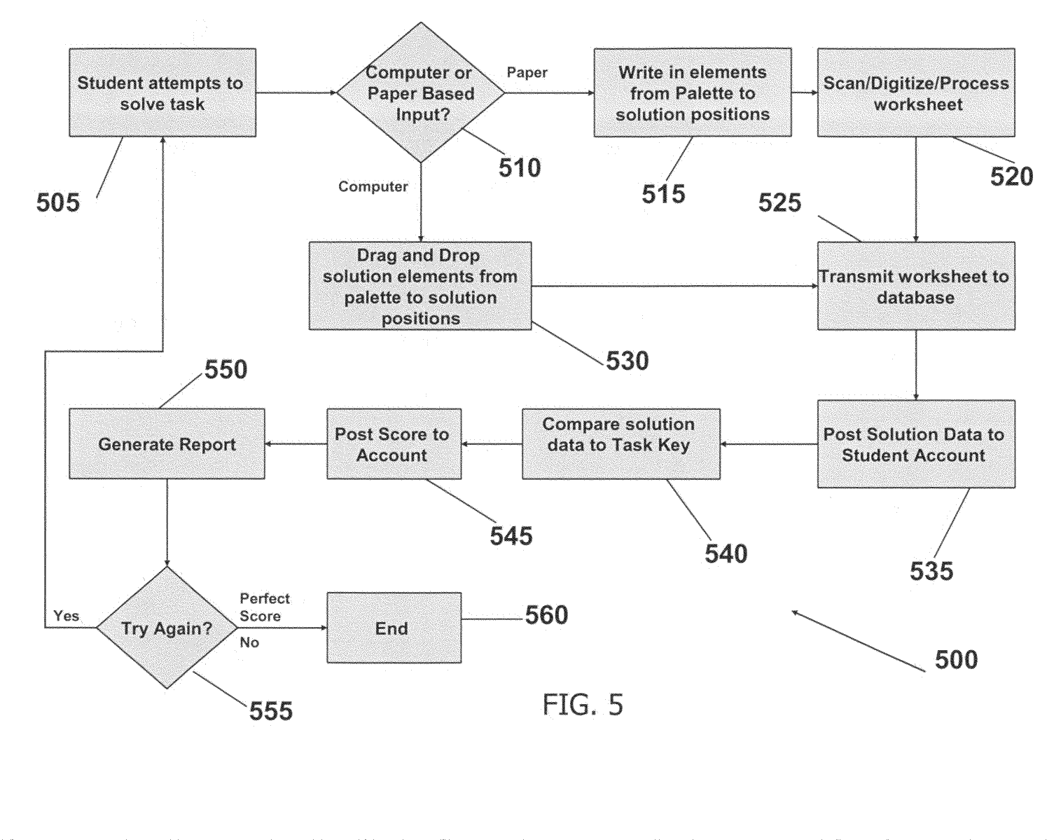

Turning now to FIG. 5, a method 500 of capturing student workflow in accordance with an embodiment of the present invention is presented. A student is presented with and attempts to solve a task 505. The student may either use a PC or paper worksheet on which to complete the task 510. If the student utilizes a paper worksheet, the student selects the appropriate answer elements from the palette or available answers and handwrites the answer element in the appropriate discrete answer location 515. When the student has filled in all of the available answer locations, the worksheet may be handed in to the teacher. The teacher then scans the worksheet for digitizing and processing 520. During the digitizing and processing the solution to the task is extracted and an electronic file is created containing the solution. The electronic file may then be transmitted over the network to the database on the server.

If the student opts for a computer-based input, and a PC is available, the student solves the task by dragging and dropping the appropriate answer elements from the palette of available answers to the discrete answer locations 530. The student then uploads the solution over the network to the database on the server.

From this point forward in the illustrative method, the student's choice of paper-worksheet or computer-based input is irrelevant, and the files uploaded to the database are substantially identical. The solution data is extracted from the transmitted file and posted to the student's individual account on the server 535. The solutions are graded by an automatic comparison 540 of the solution to a task key stored and maintained on the server. The resulting score is then recorded to the individual student's account 545. A report may then be generated 550 reflecting the score, number of incorrect answers, identification of incorrect answers, or any other metric relating to the grading of the solution.

Upon receiving the report, the teacher may instruct the student, or the student herself may wish, to try the task again 555, in which the student again attempts to solve the task 505. When a satisfactory score is achieved, the student is finished with the assigned task 560.

While certain embodiments of the present invention described herein detail simple addition problems, one skilled in the art should recognize that the true scope of the invention is not so limited. The use of simple addition is merely a simple example used for the purposes of illustration. Any complex task, including non-mathematical tasks, requiring discrete answers may be implemented without deviating from the scope of the invention.

Additionally, while embodiments described herein describe methods of using a PC, or computer-based input, to complete the tasks, one skilled in the art should recognize that any electronic input device, e.g. personal digital assistant, smartphone, pocketPC, etc., may be implemented without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method of capturing workflow of a solution of a task having an answer:
providing a task to a user, the task having a solution input by the user;
collecting and storing the solution to electronic storage, the collecting comprising extracting the input solution from one of a computer interface or a worksheet; and
posting the solution to a user-account.

2. The method of claim 1 wherein the solution comprises an indicia of the workflow resulting in the answer.

3. The method of claim 1 further comprising analyzing the solution using an automated comparison of the solution and a key, the analysis irrespective of the use of the computer interface or the worksheet.

4. A method of teaching through capturing a workflow of a solution of a task having an answer using one of a computer interface or a worksheet, the method comprising:
presenting a user with the task, the user selecting one of the computer interface or the worksheet;
receiving a submission including a solution, the form of the solution irrespective of the selection of the computer interface or the worksheet; and
posting the solution to a user-specific account located on a server.

5. The method of claim 4 further comprising selecting a plurality of elements for a plurality of discrete solution positions, at least one of the plurality of discrete solution positions including an indicia of the workflow used in arriving at the answer.

6. The method of claim 5 wherein the solution includes the selection of the plurality of elements for the plurality of discrete solution positions.

7. The method of claim 4 further comprising comparing the solution to a key using an automated process, the comparison irrespective of whether the solution was completed through the computer interface or the worksheet.

8. The method of claim 4 further comprising posting a score to the user-specific account, the score representing a number of correctly selected plurality of elements for a plurality of discrete solution positions.

9. A method of teaching through capturing a workflow process of a student in solving a task having an answer, the method comprising:
presenting the student with the task, the student choosing a computer interface or worksheet for solving the task, the task including selecting a plurality of discrete elements from a palette for a plurality of solution positions, at least one of the plurality of solution positions including an indicia of the workflow process used in arriving at the answer;
receiving a submission including a solution to the task, the solution including the location of the plurality of discrete elements in the plurality of solution positions, the solution irrespective of the student's choice of the computer interface or the worksheet;
identifying a student account corresponding to the student;
posting the solution to a server, the server storing the solution in a database entry corresponding to the student account;
comparing the solution to a key stored on the server, the key including correct locations for the plurality of discrete elements, the comparing irrespective of the student's choice of the computer interface or the worksheet;
generating a composite score, the composite score based on the correctness of the locations of the plurality of discrete elements in the plurality of solution positions; and
storing the composite score in the database entry corresponding to the student account.

10. The method of claim 9 further comprising generating a report, the report including the composite score.
